(19) United States
(12) Patent Application Publication
(10) Pub. No.: US 2025/0118958 A1
(43) Pub. Date: Apr. 10, 2025

(54) MANAGING POWER CONSUMPTION IN A DOWNHOLE ROBOT

(71) Applicant: Saudi Arabian Oil Company, Dhahran (SA)

(72) Inventors: Robert W. Adams, Houston, TX (US); Hichem Abdelmoula, Houston, TX (US); Thomas Hillman, Missouri City, TX (US); Rami Jabari, Houston, TX (US); Max Deffenbaugh, Katy, TX (US)

(21) Appl. No.: 18/911,606

(22) Filed: Oct. 10, 2024

Related U.S. Application Data
(60) Provisional application No. 63/589,187, filed on Oct. 10, 2023.

(51) Int. Cl. H02H 7/20; B25J 11/00; B25J 13/00; E21B 47/13; E21B 47/14

(52) U.S. Cl. CPC H02H 7/20; B25J 11/00; B25J 13/006; E21B 47/13; E21B 47/14

(57) ABSTRACT

In one implementation, a downhole robot includes a housing, electrically-powered equipment configured to perform operations of the downhole robot, a power source disposed inside the housing, the power source coupled by a current flow path to provide electrical current to power to the electrically-powered equipment, and a resettable latch disposed inside the housing. The resettable latch is configured to either interrupt flow of electrical along the current flow path or allow current to flow along the current flow path in response to a signal that wirelessly penetrates the housing.

### CLAIM OF PRIORITY

This application claims the benefit and priority under 35 USC § 119(e) to U.S. Provisional Patent Application Ser. No. 63/589,187, filed on 10 Oct. 2023, the entire contents of which are hereby incorporated by reference.

### TECHNICAL FIELD

This disclosure relates to managing power consumption in a downhole robot.

### BACKGROUND

Subterranean wells can be used for a variety of purposes, including producing natural resources (e.g., oil, gas, and water), stimulating the production of natural resources, storing energy and materials, and investigating geological and other physical properties of the subsurface. Subterranean wells are generally formed by drilling boreholes and casing at least a portion of the wellbore, e.g., with steel or cement. The resulting wellbores can be vertical, horizontal, or somewhere in between in (i.e., deviated wellbores).

Wellbores will generally fill with fluids that inflow from their surroundings and, in some contexts, will also contain fluids from the surface. For example, drilling fluids will commonly be injected into wellbores that are used for oil and gas production, as well as into exploration and appraisal wellbores that are drilled, at least initially, for investigating the physical properties of the subsurface.

Different downhole properties of a wellbore—including human additions to the borehole—can be relevant to the intended uses of the wellbore. Because of factors like the size and depth of wellbores, it is generally challenging to measure downhole properties. Measuring downhole properties generally requires that sensors or other measurement equipment be positioned downhole in proximity to the subterranean locations that are to be measured.

By way of example, logging tools that include sensors or other measurement equipment can be tethered and lowered into a vertical wellbore. The tether connects the logging tool to surface equipment with a high strength cable that supports the weight of the logging tool. Either as the logging tool is lowered or after it reaches a subterranean location of interest, the measurement equipment can be used to measure downhole properties. Because of power requirements and the difficulty of transmitting signals through the earth, many tethered logging tools also include power and/or signal transmission cables. In some cases, mechanical support and other functionality is combined (e.g., wireline, E-line, coiled tubing).

Untethered robots can also carry measurement equipment to measure downhole properties. However, untethered robots are generally powered by internal sources of power (e.g., generally a battery, but also fuel cells, supercapacitors, or other sources of power can be used). Further, at least some of this power is consumed by activities other than measurement, e.g., by propulsion, by actuation of robot components, by data communication, and the like. Since the amount of volume and weight that is available for power storage in an untethered robot is limited, these activities all have tight energy budgets that demand strict control over the power consumption of the system before, during, and after measurement.

### SUMMARY

Systems and techniques for managing power consumption in a downhole robot are described. The techniques can allow a fraction or all of the power consumption to the downhole robot to be stopped. If needed, power consumption can be managed without opening a pressure vessel that houses a downhole robot and without a wired connection through a wall of the pressure vessel. Accordingly, there is a need for a non-contact method to enable and disable electrical power of untethered logging vehicles with a sealed volume.

In one implementation, a downhole robot includes a housing; electrically-powered equipment configured to perform operations of the downhole robot; a power source disposed inside the housing; and a resettable latch disposed inside the housing. The power source is coupled by a current flow path to provide electrical current to power to the electrically-powered equipment. The resettable latch is configured to either interrupt flow of electrical along the current flow path or allow current to flow along the current flow path in response to a signal that wirelessly penetrates the housing.

This and other implementations can include one or more of the following features. The resettable latch can be magnetically-resettable or acoustically-resettable. The signal can comprise a magnetic field or an acoustic pulse. The electrically-powered equipment can include at least one of a propulsion system; or a communication system; or a sensor system.

The housing can include a housing portion disposed in vicinity of the resettable latch, wherein the housing portion is formed from material that has a relatively lower permeability than a remainder of the housing. The can include a transistor switch. The resettable latch can be configured to latch the transistor switch in a conductive state in response to the signal that wirelessly penetrates the housing. The downhole robot can include isolated gate drive circuitry coupled to drive the transistor switch. The resettable latch can be configured to reversibly allow return current to flow through the resettable latch to the power source in response to the signal that wirelessly penetrates the housing. The resettable latch can be powered by a second power source that differs from the power source. The current flow path can pass through the resettable latch. The electrically-powered equipment can include a first subsystem of the downhole robot. The downhole robot can include a second electrically-powered subsystem configured to perform operations of the downhole robot and a second resettable latch disposed inside the housing and configured to reversibly allow current to flow along the second current flow path in response to a signal that wirelessly penetrates the housing. The power source can be coupled by a second current flow path to provide electrical current to power to the second electrically-powered subsystem. The housing can be configured to withstand ten megapascals of differential pressure or more.

In another implementation, the method can be performed by a downhole robot that includes a power source disposed inside a housing of the downhole robot. The method can include receiving, at a latch also disposed within the housing, a signal that wirelessly penetrates the housing, and either forming or interrupting a current flow path that couples the power source and equipment of the downhole robot in response to the signal.

This and other implementations can include one or more of the following features. Receiving the signal can include receiving a signal of sufficient strength to actuate a mechanical switch. The current flow path can be either formed or interrupted in response to the receipt of a magnetic or acoustic signal. Receiving the signal can include closing or opening a magnetically-actuatable reed switch of the latch. Either forming or interrupting the current flow path can include forming or interrupting a return current flow path. The return current flow path can pass through the latch. Forming or interrupting the current flow path can include biasing a transistor switch coupled such that the current flow path flows through main terminals of the transistor switch. The transistor switch can be biased using isolated gate drive circuitry that galvanically isolates a control terminal of the transistor switch from an input to the isolated gate drive circuitry. The equipment of the downhole robot can include at least one of: a propulsion system; or a communication system; or a sensor system.

The method can include receiving, at a second latch also disposed within the housing, a signal that wirelessly penetrates the housing; and either forming or interrupting a second current flow path that couples the power source and second equipment of the downhole robot in response to the signal.

The details of one or more implementations are set forth in the accompanying drawings and the description below. Other features, objects, and advantages will be apparent from the description and drawings, and from the claims.

### DESCRIPTION OF DRAWINGS

FIG. 1 is a schematic representation of an untethered, autonomous downhole robot designed for measuring properties downhole.

FIG. 2 is a schematic representation of one implementation of a magnetically-actuatable latch in the absence of a magnetic field.

FIG. 3 is a schematic representation of the magnetically-actuatable latch in the presence of a magnetic field.

FIG. 4 is a graph that schematically represents the timing of operations performed while latching the magnetically-actuatable latch in a conductive state and resetting the magnetically-actuatable latch in an interrupted, non-conductive state.

FIG. 5 is a schematic representation of another implementation of a magnetically-actuatable latch in the absence of a magnetic field.

Like reference symbols in the various drawings indicate like elements.

### DETAILED DESCRIPTION

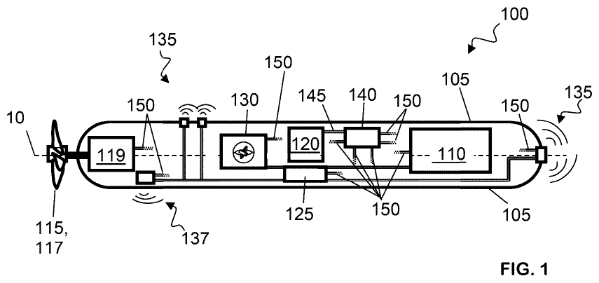

FIG. 1 is a schematic representation of a tool designed for measuring properties downhole, namely, an untethered, autonomous downhole robot 100. Robot 100 is, at least at times, self-powered, autonomous, and includes one or more sensors designed to measure downhole properties.

In more detail, robot 100 includes a housing 105, a buoyancy system 110, and a thrust-generating propulsion system 115. Housing 105 is hermetically-sealable to protect internal components of robot 100 from downhole fluids. Housing 105 is elongate and defines a long axis 10. The dimensions of housing 105 normal to long axis 10 are kept small to avoid impeding traversal through boreholes and any casing. In implementations where housing 105 has a generally circular cross-section normal to long axis 10, the dimensions normal to long axis 10 are radial. However, housing 105 need not have a generally circular cross-section normal to long axis 10 and other lateral dimensions are possible. For example, housing 105 can have square, rectangular, oval, contoured, and other cross-sections normal to long axis 10.

In some cases, dimensions of housing 105 normal to long axis 10 are small enough that robot 100 is insertable through surface or subsea equipment mounted atop a wellbore. For example, the diameter or other lateral dimension of housing 105 normal to long axis 10 of housing 105 can be a fraction (25% to 80%) of the smallest diameter or other lateral dimension that must be traversed in the wellbore. The smallest dimension can be, e.g., the inner diameter of production tubing, casing diameter of a cased completion without tubing, or the lateral dimension of an uncased (barefoot) borehole. In general, the length of robot 100 is at least twice the smallest diameter or other lateral dimension of the wellbore. Such a combination of a relatively long and narrow robot 100 allows robot 100 to be passively guided by the sidewalls of the wellbore in the event of contact during movement through the wellbore.

Housing 105 is a sealed pressure vessel that is able to withstand the pressures in the intended downhole operation. The magnitude of the pressures in a given application will depend on the depth of the wellbore and other factors, but several tens of MPa are not uncommon. Indeed, in some instances, pressures above 100 MPa must be withstood and components housed within housing 105 protected from the surroundings.

Among the components housed within housing 105 are an electrical power source 120, a controller 125, and a latch 140. Power source 120 provides electrical power to components of robot 100, including buoyancy system 110, propulsion system 115, measurement equipment (e.g., sensors 130, 135), and communications equipment. Because power source 120 is enclosed within housing 105, its capacity will be limited. Power source 120 is generally implemented as a battery, but can also be implemented as a fuel cell, a supercapacitor, a piezoelectric generator, or other source of electrical power. Power source 120 can include physically separate units (e.g., two batteries coupled in parallel) and/or diverse units (e.g., a battery and a fuel cell, or a battery and a piezoelectric generator).

Regardless of the number and the nature of the units, robot 100 includes one or more latches 140 that can latch electrical power supply and/or return lines in robot 100 into a current-carrying state or reset to an interrupted (non-current-carrying) state. In the illustrated implementation, a single latch 140 is coupled to power source 120 by an input (from the perspective of latch 140) supply line 145 and to various equipment in robot 100 by return lines 150. Please note that the powered equipment is also coupled to power source 120 by supply lines. These supply lines can be routed directly from power source 120 to the equipment or through latch 140. Regardless of how the supply lines are routed, when latch 140 is in a current-carrying state, the conduction of current between power source 120 an powered equipment in robot 100 is enabled. When latch 140 is in an interrupted state, the conduction of current between power source 120 and powered equipment in robot 100 is stopped.

In some implementations, robot 100 includes multiple latches 140 each associated with an respective subsystem that is supplied with electrical power from power source 120. When associated latches 140 are in either a current-carrying state or an interrupted state, the conduction of current—and hence the supply of power to the associated subsystem—is either enabled or stopped. In some implementations, the subsystems are functionally-coherent entities in that the equipment in the subsystem all serves a functionally-related purpose. For example, the transmitter and receiver of a communications subsystem may be supplied by electrical current that, when enabled, flows through one latch 140, whereas a propulsion subsystem may be supplied by electrical current that, when enabled, flows through a second latch 140. In some implementations, the subsystems are functionally incoherent or mixed in that power is provided to diverse equipment that lacks a straightforward functional relationship. For example, both steering components and data transmission components may be supplied by current that flows though one latch 140 associated with a first subsystem, whereas thrust-generating components and data storage components may be supplied by current that flows through a second latch 140.

Regardless of the number and disposition of latch(es) 140, each latch 140 can be internal to housing 105 and switchable between states without unsealing housing 105. For example, latch(es) 140 can be magnetically-actuatable in that application of a sufficiently high magnetic field through the pressure vessel of housing 105 can actuate latch(es) 140 and latch it/them in either a current-carrying state or reset it/them into an interrupted (non-current-carrying) state. Power consumption can thus be managed without opening the pressure vessel and without a wired connection through a wall of the pressure vessel. In some implementations, at least a portion of the pressure vessel that forms housing 105 in the vicinity of magnetically-actuatable latch(es) 140 is formed from material that has a relatively low permeability. For example, low permeability metals (e.g., stainless steels, especially those with high austenite stability, copper, aluminum) can be used.

Controller 115 is generally implemented by one or more data processors that perform operations in accordance with the logic of machine-readable instructions. The instructions can be embodied in software, in firmware, in hardware, or in combinations thereof. The operations can include navigating a wellbore, controlling logging or other information collection, and, in some cases, communicating with external equipment, including equipment on the surface.

To navigate a wellbore, controller 115 can receive information regarding a wellbore and the disposition of robot 100 within the wellbore. Further, controller 115 can control the operation of buoyancy system 110 and propulsion system 115 based on the received information.

The information relevant to navigating the wellbore can include geometric and possibly other structural information regarding the walls and other features of the wellbore, as well as information regarding fluid downhole in the wellbore. For example, robot 100 can include vibrating components 135 that generate acoustic signals for echolocating the walls of a wellbore, shift in resonant frequency and damping with fluid density and viscosity, or both. Density measurements can be relevant to navigation when using a buoyancy system in navigating the wellbore. Robot 100 can alternatively or additionally include a variety of other sensors that provide navigational information, including cameras and other electromagnetic sensors, magnetometers, collar detectors, temperature sensors, and chemical sensors. Controller 115 can receive navigational information from any of these sensors.

The information regarding the disposition of robot 100 within the wellbore can include, e.g., the orientation/inclination and depth of robot 100 within the wellbore and the speed and direction of robot 100 within downhole fluid in the wellbore. For example, robot 100 can include a gyroscopic orientation sensor 130, an inertial measurement unit (IMU), an accelerometer, an inclinometer, an attitude and heading reference system (AHRS), or other orientation sensor. In some cases, a single sensor can provide information regarding the wellbore and information regarding the disposition of robot 100 within the wellbore. For example, collar detectors can both detect collars in the wellbore and provide information regarding the depth of robot 100 within the wellbore.

In addition to sensor(s) that sense downhole properties relevant to navigating the wellbore, robot 100 also includes one or more sensors 137 that sense downhole properties relevant to characterizing the wellbore. For example, sensors 137 can measure physical properties of downhole fluids, physical properties of components that have been introduced into the borehole (e.g., casings, joints, mud, cement, packers, other tubing), and/or the native physical properties of formations around the wellbore. Example physical properties include electrical, electromagnetic, acoustical, mechanical, compositional, fluid content, density, flow properties, and the like. In some cases, a single sensor 135, 137 senses properties that are relevant to navigating the wellbore and to characterizing the wellbore. Controller 115 can receive wellbore characterization information from the sensor(s) and store and/or communicate the characterization information, as needed.

As discussed above, robot 100 includes both a buoyancy system 110 and a propulsion system 115. Propulsion system 115 is configured to drive robot 100 through downhole fluid by generating thrust. Propulsion system 115 can include a propeller 117 driven by an electric motor 119 (as illustrated), an impeller, or other thrust-generating component, as well as a motor 119 or other actuator. In some implementations, robot 100 also includes steering components that help determine the trajectory of robot 100 within downhole fluid. Example steering components include rudders, hydroplanes, drag-generating components, and/or mechanisms for controlling the direction of the thrust generated by the thrust-generating components. For example, propulsion system 115 may be configured to control the direction of the thrust that it generates using, e.g., a steerable or variable-pitch propeller. In the illustrated implementation, propeller 117 is stern-mounted (i.e., at the rear of robot 100, at least during descent) and acts as a push propeller. In the illustrated implementation, propeller 117 is coaxially mounted with long axis 10.

At least at times, power source 120—which is housed within housing 105—powers propulsion system 115. Robot 100 thus need not be tethered for propulsion system 115 to drive robot 100 through downhole fluid.

Buoyancy system 110 can provide a low-power complement to propulsion system 115 in navigating a wellbore. By controlling the buoyancy of robot 100 relative to the surrounding downhole fluid, buoyancy system 110 can move robot 100 vertically. Further, in some implementations, by controlling the longitudinal distribution of weight in robot 100—and hence the longitudinal distribution of buoyancy—buoyancy system 110 can also help steer robot 100 within a downhole fluid.

Latches 140 can be implemented in a variety of different ways. Most commonly, magnetically-actuatable reed switches can be used. Commercially available magnetically-actuatable reed switches can withstand downhole operating conditions. In some instances, other types of latches 140 can be used.

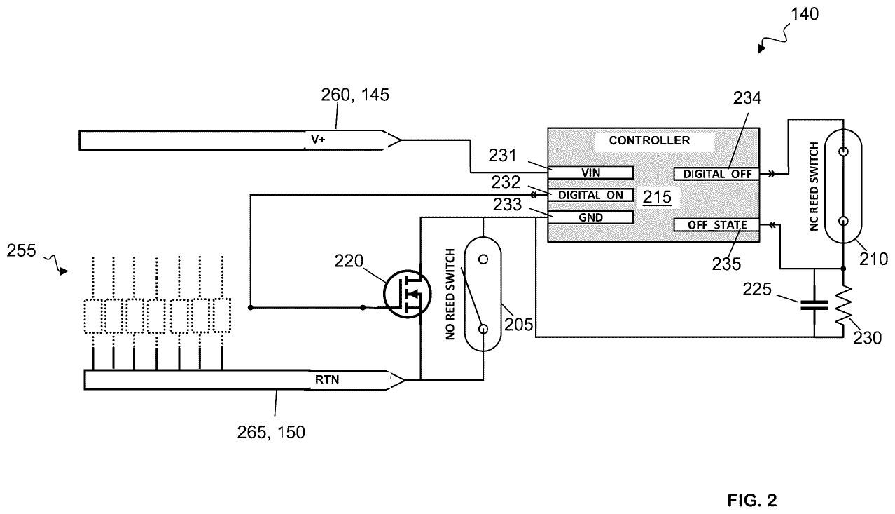

FIG. 2 is a schematic representation of one implementation of a magnetically-actuatable latch 140 in the absence of a magnetic field. The illustrated implementation includes a pair of magnetically-actuatable reed switches, namely, a normally-open reed switch 205 and a normally-closed reed switch 210. Under the control of controller 215, magnetically-actuatable latch 140 is in either a current-carrying state or an interrupted (non-current-carrying) state. As explained in further detail below, the state that is represented in FIG. 2 can either be the current-carrying state or an interrupted (non-current-carrying) state, depending on the history of the switch and the bias applied to transistor switch 220 by controller 215.

In more detail, the illustrated magnetically-actuatable latch 140 includes a supply rail 260 and a current return rail 265. Supply rail 260 can be coupled to receive a supply voltage from power source 120 and—along with a supply return line (not shown) between latch 140 and power source 120—forms input supply line 145. Latch 140 receives at least the power necessary for its own operations from supply rail 260.

Current return rail 265 couples magnetically-actuatable latch 140 to equipment 255 in robot 100. Equipment 255 can include one or more of, e.g., electric motor 119, buoyancy system 110, propulsion system 115, processor 125, measurement sensors 130, 135, communications equipment, and the like. In some cases, equipment 255 includes all of the electrically-powered equipment in robot 100. In other cases, equipment 255 includes only a fraction of the electrically-powered equipment in robot 100, e.g., a particular subsystem of the electrically-powered equipment in robot 100. In any case, equipment 255 is not part of magnetically-actuatable latch 140 and thus represented only in dashed lines. Equipment 255 is also coupled to receive a supply voltage from power source 120. In some implementations, the lines coupling equipment 255 to receive the supply voltage run through latch 140 and latch 140 also receives power for other equipment from supply rail 260. In other implementations, equipment 255 can be coupled to receive the supply voltage remotely from latch 140. For example, equipment 255 can be coupled to supply rail 260 remotely from latch 140 or coupled directly to power source 120 by individual lines. In any case, the return line for equipment 255 that can be latched by latch 140 runs through current return rail 265.

Magnetically-actuatable latch 140 includes a pair of reed switches 205, 210 and a transistor switch 220. Reed switch 205 is illustrated as a single pole, single throw, normally open switch. Reed switch 205 is coupled in parallel with transistor switch 220 between current return rail 265 and a ground return terminal 233 of controller 215. Reed switch 205 switches from its normally open state into a closed state in response to a non-contact magnetic signal, i.e., a magnetic field.

Reed switch 210 is illustrated as a single pole, single throw, normally closed switch. Reed switch 210 is coupled between a digital_off terminal 234 and a OFF_state terminal 235 of controller 215. OFF_state terminal 235 and the respective terminal of reed switch 210 are coupled to a ground return terminal 233 of controller 215 by a parallel arrangement of a capacitor 225 and a resistor 230. Reed switch 210 switches from its normally closed state into a open state in response to a non-contact magnetic signal.

In general, reed switches 205, 210 are both switched by the same magnetic field applied to latch 140 and robot 100. For example, in some implementations, reed switches 205, 210 are positioned in the vicinity of the same portion of housing 105 that is formed of material that has a relatively low permeability. This is however not necessarily the case and, in some implementations, reed switches 205, 210 are spaced apart and/or respond to different signals that wirelessly penetrate housing 105 of robot 100. As another alternative, in some implementations, a single pole double throw switch that can be used to implement the same logic as switches 205, 210.

In other implementation, reed switches 205, 210 can be replaced by switches that respond to other types of signals that wirelessly penetrate housing 105 of robot 100, e.g., mechanical motion, acoustic vibration, light, temperature, or the like. Thus, latch 140 need not be magnetically-actuatable in all implementations.

In addition to reed switches 205, 210 and transistor switch 220, magnetically-actuatable latch 140 also includes a controller 215. The illustrated embodiment of controller 215 includes terminals 231, 232, 233, 234, 235. Terminal 231 is a supply input terminal and, in operation, is coupled to supply rail 260 to input the power supplied by power source 120 into controller 215. The supplied power is consumed at least by latch 140 (e.g., by controller 215 and, at times, by biasing transistor switch 220 and terminal 235). Terminal 233 is a ground return terminal and coupled to a return line (not shown) between latch 140 and power source 120. When latch 140 is latched in the current-carrying state, the return line between latch 140 and power source 120 returns current consumed by latch 140 and equipment 255. When latch 140 is reset and in the interrupted state, the return line between latch 140 and power source 120 does not return current consumed by equipment 255. Rather, the return line returns only the current consumed by latch 140.

Continuing with the other terminals of controller 215, terminal 232 is designated as a digital_on terminal, terminal 234 as a digital_off terminal, and terminal 234 as an off_state terminal. Controller 215 is configured to respond to signals that wirelessly penetrate housing 105 of robot 100 and that indicate that latch 140 is to be latched in the current-carrying state by outputting a signal on terminal 232 that maintains a conductive current return path for equipment 255. In other words, controller 215 responds to these signals by latching latch 140 in the current-carrying state. In the illustrated implementation, this conductive current return path passes through transistor switch 220. Transistor switch 220 can be implemented as an enhancement mode NMOS transistor that is driven into saturation by gate voltages that are consistent with the digital logic of controller 215. Other implementations are of possible.

Controller 215 is also configured to respond to signals that wirelessly penetrate housing 105 of robot 100 and that indicate that latch 140 is to be latched in the current-carrying state by outputting a signal on digital_off terminal 234 that biases OFF_state terminal 235 with a signal that indicates that controller 215 is latched in the current-carrying state. The bias on OFF_state terminal 235 is determined by the signal output from digital_off terminal 234 and the parallel combination of capacitor 225 and resistor 230. Controller 215 can respond to changes in the biasing of OFF_state terminal 235. These changes indicate that latch 140 is to be reset and returned to an interrupted, non-current-carrying state.

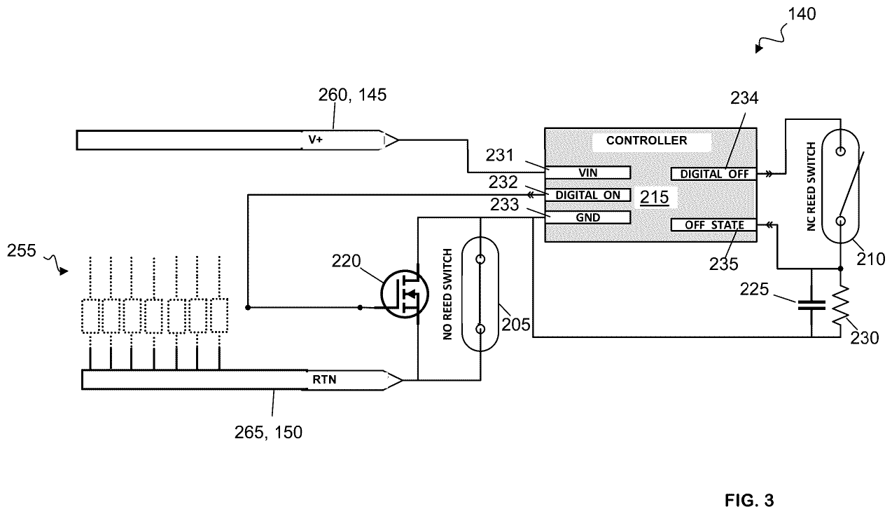

FIG. 3 is a schematic representation of magnetically-actuatable latch 140 in the presence of a magnetic field. In the presence of a magnetic field, normally-open reed switch 205 closes and normally-closed reed switch 210 opens. The closing of normally-open reed switch 205 forms a conductive current patent between current return rail 265 and ground return terminal 233. The opening of normally-closed reed switch 210 interrupts the current flow path between digital_off terminal 234 and off_state terminal 235.

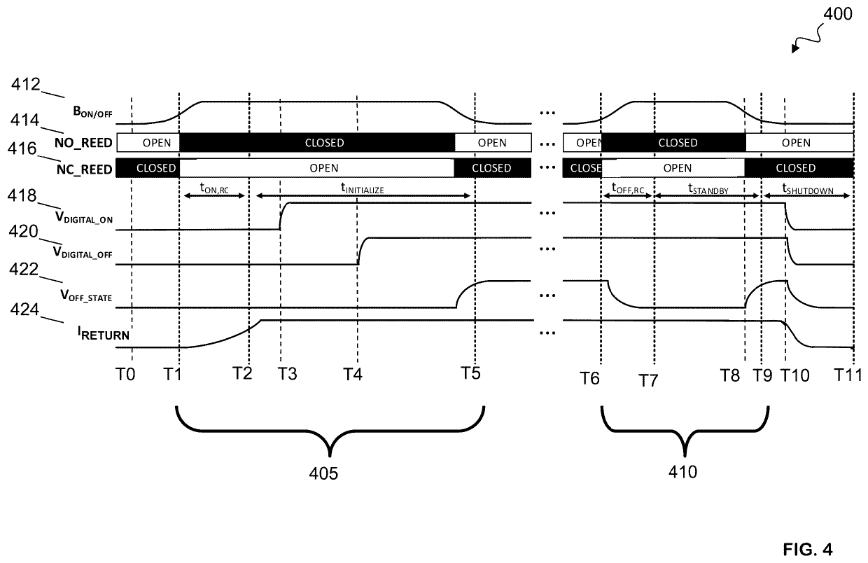

FIG. 4 is a graph 400 that schematically represents the timing of operations performed while latching 405 magnetically-actuatable latch 140 in a conductive state and resetting 145 magnetically-actuatable latch 140 in an interrupted, non-conductive state.

Graph 400 includes a number of time traces 412, 414, 416, 418, 420, 422, 424 that represent occurrences and states within magnetically-actuatable latch 140 on a common time x-axis. The y-axes of traces 412, 414, 416, 418, 420, 422, 424 are however not necessarily to scale, even when traces 412, 414, 416, 418, 420, 422, 424 share the same units.

In particular, trace 412 represents the magnetic field applied to latch 140. In the illustrated implementation, reed switches 205, 210 are both switched by the same magnetic field represented in trace 412.

Trace 414 represents the state of normally open reed switch 205 within latch 140. The possible states of reed switch 205 are, for practical purposes, digital (i.e., either open or closed). The open state of reed switch 205 is represented in trace 414 in white whereas the closed state of reed switch 205 is represented in trace 414 in black.

Trace 416 represents the state of normally closed reed switch 210 within latch 140. Once again, open state is represented in white whereas the closed state is represented in black.

Trace 418 represents the voltage output by controller 215 on digital_on terminal 232 within latch 140 to bias transistor switch 220 into and out of conduction. In some cases, the magnitude of the voltages on output terminal 232 are consistent with the digital logic “high” and “low” within controller 215. For purposes of latch 140, the possible states of transistor switch 220 are also digital (i.e., either open or closed), consistent with the digital logic within controller 215.

Trace 420 represents the voltage output by controller 215 on digital_off terminal 234 within latch 140 to bias off_state terminal 235. Once again, the magnitude of the voltages on digital_off terminal 234 can be consistent with the digital logic “high” and “low” within controller 215.

Trace 422 represents the voltage of off_state terminal 235 within latch 140. As discussed below, controller 215 can monitor the voltage of off_state terminal 235 to detect opening and closing of normally closed reed switch 210 responsive to an applied magnetic field.

Trace 424 represents the return current that flows through latch 140, i.e., the return of current that flows from power source 120, though equipment 255 and current return rail 265, and then through either or both of transistor switch 220 and normally-open reed switch 205, ground return terminal 233, and the return line between latch 140 and power source 120.

Turning to the designated times, at time T0, latch 140 is in the non-conductive state. Time T0 can represent either an initial state (e.g., after start-up) or a reset state after robot 100 has been used. In other words, time T0 can correspond to time T11 from a previous latch/reset cycle. In either case, normally-open reed switch 205 is open (trace 414) and normally-closed reed switch 210 is closed (trace 416). None of digital_on terminal 232 (trace 418), digital_off terminal 234 (trace 420), and off_state terminal 235 (trace 422) is biased. With an enhancement-mode transistor switch 220, the absence of a bias on digital_on terminal 232 (trace 418) means that transistor switch 220 does not conduct a meaningful amount of current. Both transistor switch 220 and normally-open reed switch 205 are thus “open” and no return current from equipment 255 (trace 424) flows through latch 140.

Between times T0 and T1, a magnetic field is applied to latch 140 (trace 412). At time T1, the magnitude of the magnetic field is sufficiently large to close normally-open reed switch 205 (trace 414) and open normally-closed reed switch 210 (trace 416). Since normally-open reed switch 205 is in the current return path from equipment 255, return current from equipment 255 starts to flows through latch 140 (trace 424). In the illustrated implementation, the return current requires time to reach its maximum operational value. This delay can be due to, e.g., “powering up” at equipment 255, reactance of the current flow path, and the like.

Between times T1 and T2, the return current from equipment 255 continues to increase (trace 424). At time T2, the return current has increased to a sufficiently high level that initialization processes at controller 215 can be performed.

The initialization processes can be performed in a variety of different orders. However, in the illustrated implementation, at time T3, controller 215 biases digital_on terminal 232 (trace 418) such that transistor switch 220 switches into conduction. Transistor switch 220 thus forms a current conducting path for return current from equipment 255. Until shortly before time T5, the current conducting path through transistor switch 220 is in parallel with current conducting path through normally-open reed switch 205, which remains closed due to the applied magnetic field (trace 412).

At time T4, controller 215 biases digital_off terminal 234 (trace 420). With normally-closed reed switch 210 remaining open due to the applied magnetic field (trace 412), digital_off terminal 234 is isolated from off_state terminal 235 and digital_off terminal 234 quickly rises to the applied bias level.

Between times T4 and T5, the magnetic field becomes insufficient (trace 412) to maintain normally-open reed switch 205 in the closed state (trace 414) and maintain normally-closed reed switch 210 in the open state (trace 416). When normally-closed reed switch 210 opens, this does not interrupt the return current path through latch 140. Rather, the return current path is maintained through transistor switch 220 due to the bias applied by digital_on terminal 232 (trace 418).

However, when normally-closed reed switch 210 closes, the bias applied to digital_off terminal 234 can bias off_state terminal 235 and latch 140 in the conductive state. By time T5, capacitor 225 is sufficiently charged that latch 140 is latched. In the conductive state, latch 140 can remain latched so long as power is available to supply controller 215, to bias transistor switch 220 from digital_on terminal 232, and to bias off_state terminal 235 from digital_off terminal 234.

After time T5 and prior to time T6, latch 140 is latched in the conductive state. In particular, normally-open reed switch 205 is open (trace 414) and normally-closed reed switch 210 is closed (trace 416). Controller 215 biases digital_on terminal 232 (trace 418), digital_off terminal 234 (trace 420), and off_state terminal 235 (trace 422). With an enhancement-mode transistor switch 220, the presence of a bias on digital_on terminal 232 (trace 418) means that transistor switch 220 conducts and return current from equipment 255 (trace 424) flows through latch 140.

Immediately prior to time T6, a magnetic field is applied to latch 140 (trace 412). At time T6, the magnitude of the magnetic field is sufficiently large to close normally-open reed switch 205 (trace 414) and open normally-closed reed switch 210 (trace 416). Since normally-open reed switch 205 is in parallel with transistor switch 220, return current from equipment 255 (trace 424) continues to flow through latch 140. However, with normally-closed reed switch 210 open, digital_off terminal 234 is no longer able to maintain the bias on off_state terminal 235 (trace 422). Instead, the bias on off_state terminal 235 dissipates through resistor 230.

Further, this discharge can be sensed by controller 215 which—at time T7—enters a standby state. In the standby state, controller 215 monitors off_state terminal 235 (trace 422) for a subsequent increase. While in the standby state, controller 215 continues biasing both digital_on terminal 232 (trace 418) and digital_off terminal 234 (trace 420) and return current continues to flow through transistor switch 220 (trace 424).

Subsequently, the magnetic field is removed and, at time T8, falls below a level that suffices to close normally-open reed switch 205 and open normally-closed reed switch 210 (traces 412, 414, 416). Although normally-open reed switch 205 remains open, a conductive current path is maintained through transistor switch 220 and return current continues to flow (trace 424). However, with normally-closed reed switch 210 closing, a conductive path is formed between digital_off terminal 234 and off_state terminal 235. The potential on off_state terminal 235 starts to rise as a potential is developed across capacitor 225 and resistor 230 (trace 422).

At time T9, the potential on off_state terminal 235 rises above a threshold and controller 215 initiates operations to shut down the current path through latch 140. At time T10, controller 215 discontinues biasing digital_on terminal 232 (trace 418), digital_off terminal 234 (trace 420). With digital_on terminal 232 no longer being biased, the conductive current path through transistor switch 220 is no longer maintained and return current stops flowing through latch 140 (trace 424). With digital_off terminal 234 no longer being biased, the potential on off_state terminal 235 discharges through resistor 230 (trace 422). Both off_state terminal 235 and digital_off terminal 234 soon settle at the potential of ground return terminal 233 (traces 420, 422).

By time T11, the return current from equipment 255 is zero (trace 424) and both off_state terminal 235 and digital_off terminal 234 are fully settled at the potential of ground return terminal 233 (traces 420, 422). Latch 140 has thus been reset into the same state as it was at time T0.

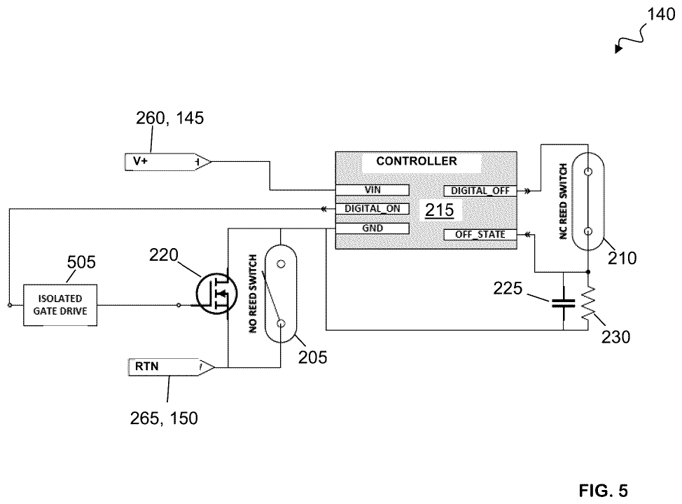

FIG. 5 is a schematic representation of another implementation of a magnetically-actuatable latch 140 in the absence of a magnetic field. The illustrated implementation shares many common features with the implementation represented in FIGS. 2, 3 and, for the sake of brevity, like elements are designated with corresponding reference numbers and unduly repetitive description is omitted.

In the illustrated implementation, a ground plane of ground return terminal 233 is galvanically isolated from the return plane on current return rail 265. This isolation minimizes leakage current. At least some of the circuitry in controller 215 is referenced to the ground plane, including the circuitry that generates the signal on digital_on terminal 232. However, the source of transistor switch 220 is coupled to current return rail 265 and referenced to the return plane. Since the ground plane and the return plane are galvanically isolated and float with respect to one another, latch 140 is adapted to ensure that the voltages between the gate of transistor switch 220 and the source of transistor switch 220 are effective to control the state of transistor switch 220.

In particular, magnetically-actuatable latch 140 includes isolated gate drive circuitry 505 coupled between digital_on terminal 232 and the control terminal of transistor switch 220. Isolated gate drive circuitry 505 is configured to galvanically isolate its input from digital_on terminal 232 from its output to the control terminal of transistor switch 220. Isolated gate drivers are commercially available and generally rely upon inductive or capacitive couplers to convey switching control signals and power from input to output. In some implementations, digital_on terminal 232 can directly output a signal that is capable of traversing the galvanic isolation. In other implementations, digital_on terminal 232 outputs a signal with digital logic “high” and “low” section (such as shown in trace 418) and isolated gate drive circuitry 505 converts the logic into a signal suitable for communicating across the galvanic isolation.

A number of implementations have been described. Nevertheless, it will be understood that various modifications may be made. For example, rather than powering latch 140 from the same power source 120 that provides power to other equipment, latch 140 can be powered by a dedicated power source. For example, latch 140 can be powered by a dedicated battery or by an energy harvesting system (e.g., a piezoelectric harvesting system). This would prevent the small current required by latch 140 from draining power source 120 in long-term storage.

As another example, latch 140 and/or robot 100 can have additional states. For example, latch 140 and/or robot 100 can have a long-term storage state (e.g., a “sleep” state) in which latch 140 does not draw power at all. Rather, an external source of energy must be used to “wake” robot 100 and begin powering robot 100 from power source 120.

Accordingly, other implementation are within the scope of the following claims.

What is claimed is:

1. A downhole robot comprising:
a housing;
electrically-powered equipment configured to perform operations of the downhole robot;
a power source disposed inside the housing, the power source coupled by a current flow path to provide electrical current to power to the electrically-powered equipment; and
a resettable latch disposed inside the housing, wherein the resettable latch is configured to either interrupt flow of electrical along the current flow path or allow current to flow along the current flow path in response to a signal that wirelessly penetrates the housing.

2. The downhole robot of claim 1, wherein:
the resettable latch is magnetically-resettable or acoustically-resettable; and
the signal comprises a magnetic field or an acoustic pulse.

3. The downhole robot of claim 1, wherein the electrically-powered equipment includes at least one of:
a propulsion system; or
a communication system; or
a sensor system.

4. The downhole robot of claim 1, wherein the housing comprises a housing portion disposed in vicinity of the resettable latch, wherein the housing portion is formed from material that has a relatively lower permeability than a remainder of the housing.

5. The downhole robot of claim 1, wherein the downhole robot comprises:
a transistor switch, wherein the resettable latch is configured to latch the transistor switch in a conductive state in response to the signal that wirelessly penetrates the housing.

6. The downhole robot of claim 5, wherein the downhole robot comprises isolated gate drive circuitry coupled to drive the transistor switch.

7. The downhole robot of claim 1, wherein the resettable latch is configured to reversibly allow return current to flow through the resettable latch to the power source in response to the signal that wirelessly penetrates the housing.

8. The downhole robot of claim 1, wherein the resettable latch is powered by a second power source that differs from the power source.

9. The downhole robot of claim 1, wherein the current flow path passes through the resettable latch.

10. The downhole robot of claim 1, wherein:
the electrically-powered equipment comprises a first subsystem of the downhole robot; and
wherein the downhole robot further comprises:
a second electrically-powered subsystem configured to perform operations of the downhole robot, wherein the power source is coupled by a second current flow path to provide electrical current to power to the second electrically-powered subsystem, and
a second resettable latch disposed inside the housing and configured to reversibly allow current to flow along the second current flow path in response to a signal that wirelessly penetrates the housing.

11. The downhole robot of claim 1, wherein the housing is configured to withstand ten megapascals of differential pressure or more.

12. A method performed by a downhole robot that comprises a power source disposed inside a housing of the downhole robot, the method comprising:
receiving, at a latch also disposed within the housing, a signal that wirelessly penetrates the housing; and
either forming or interrupting a current flow path that couples the power source and equipment of the downhole robot in response to the signal.

13. The method of claim 12, wherein receiving the signal comprises receiving a signal of sufficient strength to actuate a mechanical switch, wherein the current flow path is either formed or interrupted in response to the receipt of a magnetic or acoustic signal.

14. The method of claim 12, wherein receiving the signal comprises closing or opening a magnetically-actuatable reed switch of the latch.

15. The method of claim 12, wherein either forming or interrupting the current flow path comprises forming or interrupting a return current flow path.

16. The method of claim 15, wherein the return current flow path passes through the latch.

17. The method of claim 12, wherein forming or interrupting the current flow path comprising biasing a transistor switch coupled such that the current flow path flows through main terminals of the transistor switch.

18. The method of claim 17, wherein biasing the transistor switch comprises biasing the transistor switch using isolated gate drive circuitry that galvanically isolates a control terminal of the transistor switch from an input to the isolated gate drive circuitry.

19. The method of claim 12, wherein the equipment of the downhole robot includes at least one of:
a propulsion system; or
a communication system; or
a sensor system.

20. The method of claim 12, further comprising:
receiving, at a second latch also disposed within the housing, a signal that wirelessly penetrates the housing; and
either forming or interrupting a second current flow path that couples the power source and second equipment of the downhole robot in response to the signal.
